(19) United States
(12) Patent Application Publication
(10) Pub. No.: US 2007/0033128 A1
(43) Pub. Date: Feb. 8, 2007

(54) Method for funding a health information network entity

(75) Inventor: Douglas S. McNair, Leawood, KS (US)

Correspondence Address: SHOOK, HARDY & BACON L.L.P.;Intellectual Property Department, 2555 GRAND BOULEVARD, KANSAS CITY, MO, 64108-2613, US

(73) Assignee: Cerner Innovation, Inc., Overland Park, KS (US)

(21) Appl. No.: 11/334,759

(22) Filed: Jan. 18, 2006

Related U.S. Application Data
(60) Provisional application No. 60/644,881, filed on Jan. 18, 2005.

(51) Int. Cl. G06Q 40/00

(52) U.S. Cl. 705/36 R

(57) ABSTRACT

Methods for updating a task list from an action item documentation view are provided. In one embodiment, a method of the present invention may include creating an health information network fund in which a portion of the assessed investment fund fees and/or investment fund service providers' fees and/or capital gains are designated for underwriting a health information network such as a National Health Information Network organization (NHIN) and/or Regional Health Information Organizations (RHIOs) as directed by the investment fund's manager and general partner. Shareholders of one or more open-ended fund share classes (such as mutual fund share classes, or exchange-traded funds (ETFs)) and closed-ended unit investment trust (UIT) share classes designate one or more NHIN and RHIO entities to receive the accumulated amounts attributable to their individual accounts. Transferred amounts are then tracked and paid to these NHIN and RHIO entities on a periodic basis according to the designations on the records of the investment fund.

### CROSS-REFERENCE TO RELATED APPLICATIONS

This application claims the benefit of priority of U.S. Provisional Application No. 60/644,881 filed on Jan. 18, 2005.

### STATEMENT REGARDING FEDERALLY SPONSORED RESEARCH OR DEVELOPMENT

Not applicable.

### TECHNICAL FIELD

The present invention relates to method of funding a healthcare information network entity. More particularly, embodiments of the present invention relate to methods for funding National Health Information Network (NHIN) organizations or Regional Health Information Organizations (RHIOs).

### BACKGROUND OF THE INVENTION

Recent initiatives to establish nation-wide and regional health information networks have been troubled by lack of adequate public financing. NHIN and RHIOs entities are constrained to operate as not-for-profit “utility-like” organizations. If the entities are organized as 501(c)(3) organizations or as units of government agencies, then they are restricted from raising capital through issuance of private equity. Various financial vehicles exist, but they tend to have high expense ratios, require setting aside entire investments for the purposes set forth at the time of establishment of the fund, fail to produce an ongoing revenue stream, and/or do not produce any direct return for the investors.

Thus a need exists for an investment vehicle that permits investors to minimize the investment risk and pursue competitive rates of return while contributing ongoing income streams to the funds of interest to NHIN and RHIO entities and their investors. Accordingly, a method for funding health information network entities would be advantageous.

### BRIEF SUMMARY OF THE INVENTION

Embodiments of the present invention provide methods for funding health information network entities. In one embodiment, the present invention is an investment fund in which a portion of the assessed fund fees and/or vendor service fees and/or capital gains are set aside by the fund's manager for distribution to NHIN and RHIO entities as directed by the fund's general partner and investment advisor. Shareholders designate one or more NHIN or RHIO entities to receive the accumulated amounts that result from their proportionate investment in the investment fund. Such amounts are tracked and paid to NHIN or RHIO entities on a periodic basis according to records held on the investment fund's transfer agent system. The NHIN or RHIO entities and shareholders each receive reports regarding the fund payments.

In some cases, shareholders may elect to donate all or part of their investment, or all or part of their gains distributions, to one or more of the 501(c)(3) NHIN or RHIO entities. Each such entity designated receives a statement along with the periodic payment that identifies the amounts donated and a list of the corresponding shareholder donors, although donor shareholders have the ability to remain anonymous if desired. Each donor shareholder receives a summary of their portion of the investment fund's donation on their periodic statement. The portion of the investment fund manager's fees or other service providers' fees to be donated to the NHIN or RHIO entities, may be disclosed as a separate line item in the investment fund's prospectus expense table.

One advantage of the present invention for sponsors (e.g. fund investment advisors and service providers) is that the sponsors and affiliated departments and brokers are able to attract a new market segment, thereby increasing assets under management and generating new reoccurring revenues and sales commissions. The principal advantages of the invention for NHIN or RHIO entities are a new source for recurring revenue streams and for access to capital in a highly liquid market. A further advantage is that 501(c)(3) organizations, including the NHIN and RHIOs themselves, can invest in these funds under current U.S. SEC law, provided that they have assets in excess of $5M. Other advantages are apparent from the detailed description of the invention.

### BRIEF DESCRIPTION OF THE SEVERAL VIEWS OF THE DRAWING

The present invention is described in detail below with reference to the attached drawing figures, wherein:

FIG. 1 is a flow chart representative of a method for initially offering open-ended mutual fund shares in accordance with an embodiment of the present invention;

FIG. 2 is a flow chart representative of a method for establishing fund donation expenses in accordance with an embodiment of the present invention;

FIG. 3 is a flow chart representative of a method for fund account application and creation in accordance with an embodiment of the present invention; and

FIG. 4 is a flow chart representative of a method for daily funds operation in accordance with an embodiment of the present invention.

### DETAILED DESCRIPTION OF THE INVENTION

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The present invention provides a method for funding a health information network entity. Specifically, a feasible financial vehicle for achieving the necessary private capitalization is investment funds, such as special NHIN- or RHIO-oriented mutual funds or exchange-traded funds described in this patent as Health Information Network Funds (HINFs) or unit investment trusts (UITs), in which large groups of individuals, provider and payer organizations, institutional investors, government agencies, and the NHIN and RHIOs themselves may specifically underwrite the creation and operations of NHIN and RHIO organizations. Such investment funds accomplish the goals of achieving a higher level of investment and liquidity than could be reached through public general fund appropriations or public debt issuance, and of reducing investment risk by diversifying the NHIN and RHIO investments by spreading the risk among a greater number and types of investments than investors or the governments could conveniently do independently. Also, the general partner and investment advisor provide professional investment and money management experience to operate the fund so as to meet the objectives for financial return and to conform to applicable SEC and other regulations. The individual investors are assessed fees in connection with the operation of the mutual fund, typically calculated as a percentage of the assets during a given period of time and/or transaction fees on the sale or purchases of investments. The fund itself may also pay a variety of fees to third party service providers.

Types of investment funds include investment companies, common trust and collective trust funds, and hedge funds. Investment companies are comprised of four main types of investment vehicles: mutual funds, closed-end funds, unit investment trusts, and exchange-traded funds. A closed-end fund is a type of investment company that has a fixed number of shares that are publicly traded. The price of the shares of a closed-end fund fluctuates based on investor supply and demand. Closed-end funds are not required to redeem shares and have managed portfolios. A unit investment trust (UIT) is an investment company that buys and holds a fixed number of shares until the trust's termination date. When the trust is dissolved, proceeds are paid to shareholders. A UIT has an unmanaged portfolio. Like a mutual fund, shares of a UIT can be redeemed on any business day. An exchange-traded fund (ETF) is an investment company with shares that trade intraday on stock exchanges at market-determined prices. Investors may buy or sell ETF shares through a broker just as they would the shares of any publicly traded company. Common trust and collective trust funds are asset pools for the collective investment of assets held in a fiduciary or ERISA capacity by a trust company or bank. Common trust and collective trust fund units may only be purchased or redeemed through the trust company or bank.

HINF funds that are the subject of the present patent provide a simplified format for investment in multiple NHIN or RHIO entities through a single account, summarized in regular statements. Contributions to such a fund are invested in one of several portfolios tailored to particular investment goals that are offered by the investment management company, and thus can grow before it is passed on to its ultimate NHIN and RHIO recipients. If HINF funds are organized as not-for-profit entities, then the capital gain distributions from such investments may be expected to have tax-exempt status. If an investor donates their entire investment in such HINFs, such donations would additionally be expected to have tax-deductible status.

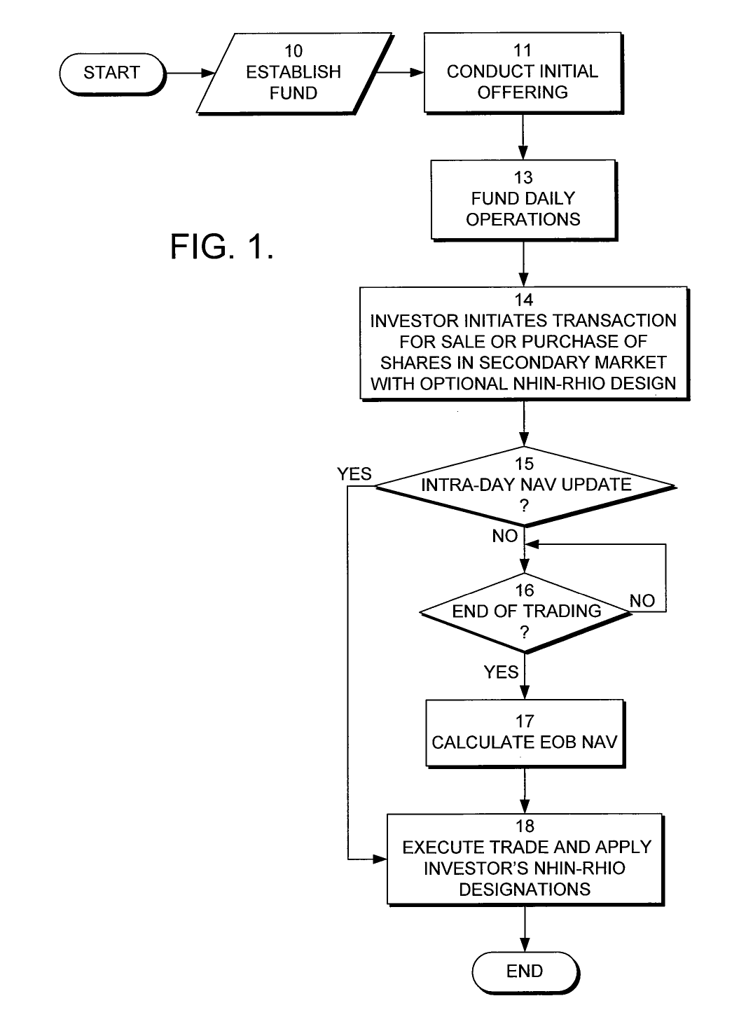

In an open-ended fund, as depicted in FIG. 1, the fund is established at block 10. Next, at block 11, the fund commences operations by offering shares to third party shareholders through an initial public offering or other offering. Shareholders may be given the option to purchase shares directly from the mutual fund or through broker agents. After the initial sale of shares and designation of one or more NHIN or RHIO entities, at block 13, the fund commences its daily operations of buying and selling securities on behalf of the investor pool by using the proceeds of the initial sale of shares as well as any subsequent share sales in the secondary market. As an open-ended fund, the fund may sell shares to the public, either directly or through broker agents after the initial issuance of shares. This contrasts with closed-end funds and UITs, in which no additional shares may be sold and the fund is limited to the initial capital raised by the initial sale of shares. Accordingly, when a new or existing investor desires to buy or sell shares at block 14, or an existing shareholder desires to sell shares, the transaction occurs, directly or indirectly, through sale or redemption of shares by the fund. The fund is required under law to sell the shares at the Net Asset Value (NAV) of the shares at the time of sale. Most funds calculate the NAV once per day after the close of traditional equity markets and conduct sales and redemptions based on that price; however, some funds do calculate the NAV on an ongoing basis (hourly) as illustrated at block 15. If the NAV is calculated on an ongoing basis, the fund can sell shares to the investor as at block 18. If the NAV is calculated at the end of the business day then the fund must wait until the end of the business day until the end of trading at block 15, before calculating the NAV at block 17 and selling shares to the investor as at block 18.

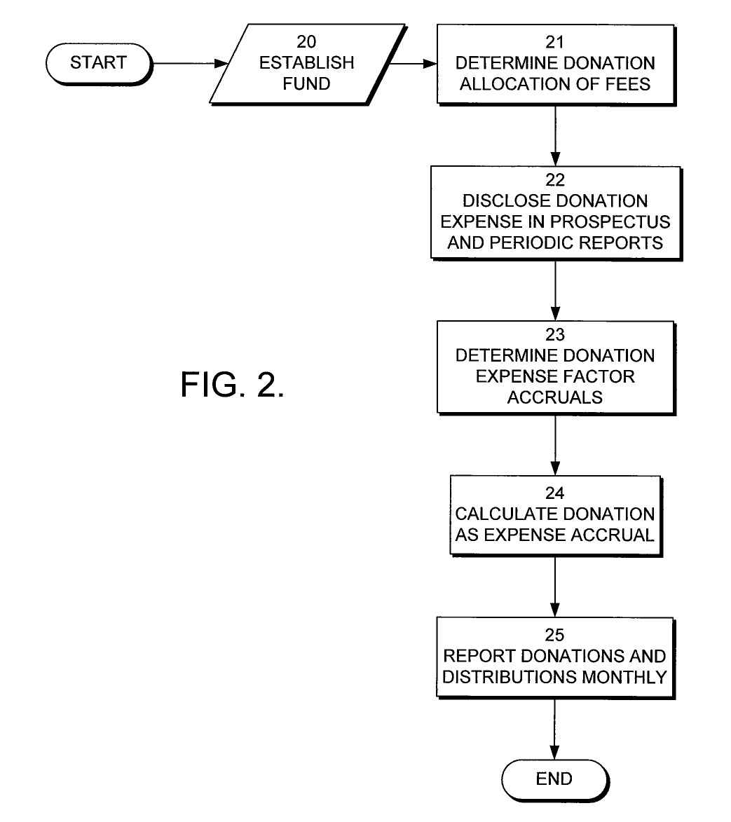

A method for establishing fund donation expenses in accordance with an embodiment of the present invention is depicted in the representative flow chart of FIG. 2. At block 20, the fund is established as the specific financial characteristics of the fund are defined (as described in FIG. 1). At block 21, it is determined whether the donation expense is to be a line item expense of the mutual fund or to be a donation paid by the fund service providers. If the donation expense is a line item of the fund it must be disclosed in the fund's prospectus expense table at block 22. After the determination of the source of the donation expense, the donation expense factor accruals are established with the transfer agent and fund accountants at block 23 to permit tracking of the accrued donation expense amounts. The fund accountant then calculates on a daily basis the donation expense accrual at block 24 either as a fund expense or as a portion of the expenses paid to participating service providers. At the time designated by the fund, preferably at the end of the month, the fund will distribute the accrued donation expenses and list such payments on the periodic account statements of its shareholders at block 25.

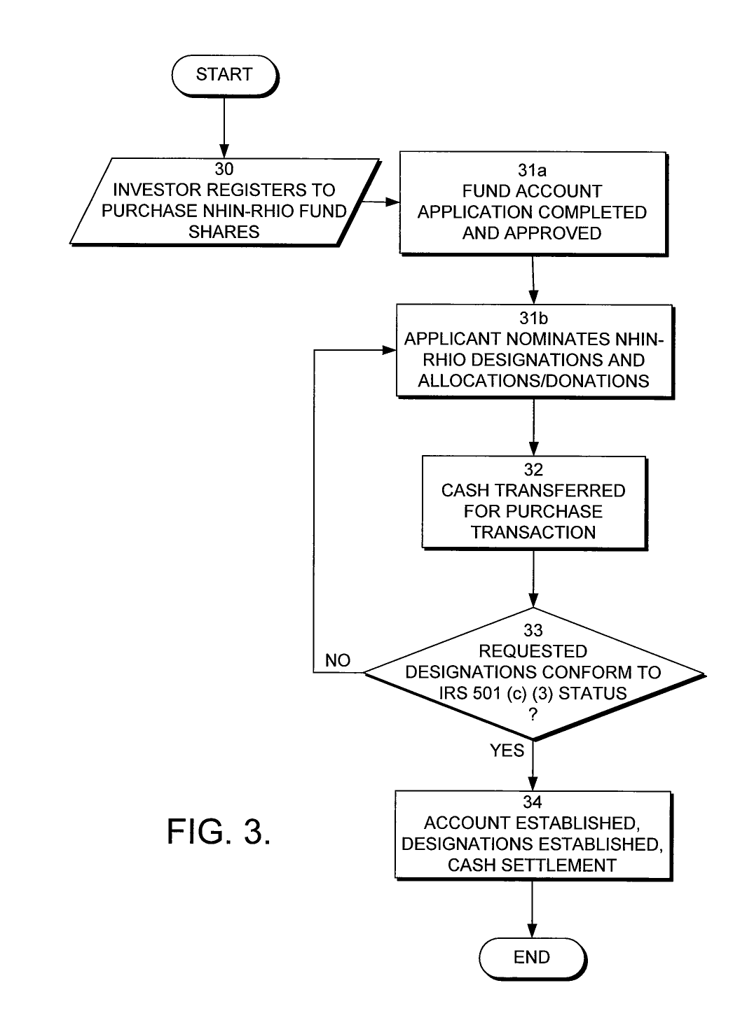

A method for fund account application and creation in accordance with an embodiment of the present invention is illustrated by representative flow diagram of FIG. 3. At block 30, an investor registers to purchase NHIN-RHIO fund shares. In order to purchase shares, investors are required to submit a fund account application form including account name and other information. At block 31a, the fund account application is completed, and approved. At block 31b, the applicant nominates NHIN-RHIO designations, allocations and donations. In an embodiment, the application form is used to obtain account the NHIN-RHIO designation information received at block 31b. At block 32, cash is transferred for the purchase transaction. The application form and monies for the investment are then forwarded to the shareholder servicing department of the mutual fund at block 33 for processing and approval or rejection. If the investor is approved, the fund then reviews the designations of the shareholder. If the designations are acceptable to the fund manager, the account is established and the shares are purchased at block 34. If the designations are unacceptable to the fund at block 33, the shareholder will be requested to amend or change his or her designations at block 31b. Within legal limits, the fund can create fund qualifications and limits. In an embodiment, the fund will limit NHIN or RHIO entities that may be designated to those NHIN or RHIO entities qualified by the U.S. Internal Revenue Service at 35, such as 501(c)(3) organizations, to gain certain tax advantages for itself and/or its shareholders and to reduce administrative oversight relating to the IRS 501(c)(3) validity of the designations. Further, in embodiments, the method will limit the number of NHIN or RHIO entities that may be designated by a shareholder to reduce the administrative effort relating to the disbursements and avoid the potential for dilution of payments caused by designation of a large number of NHIN or RHIO entities by a shareholder.

Designation of the NHIN or RHIO entities may be changed from time-to-time by the shareholder by notifying the fund of the changes. In an embodiment, the shareholder will be limited to changing his or her designation after the end of the then current donation period to simplify administration of the apportionment and payments. The frequency of changing designations and allocation amounts may also be limited by the capabilities of the transfer agent.

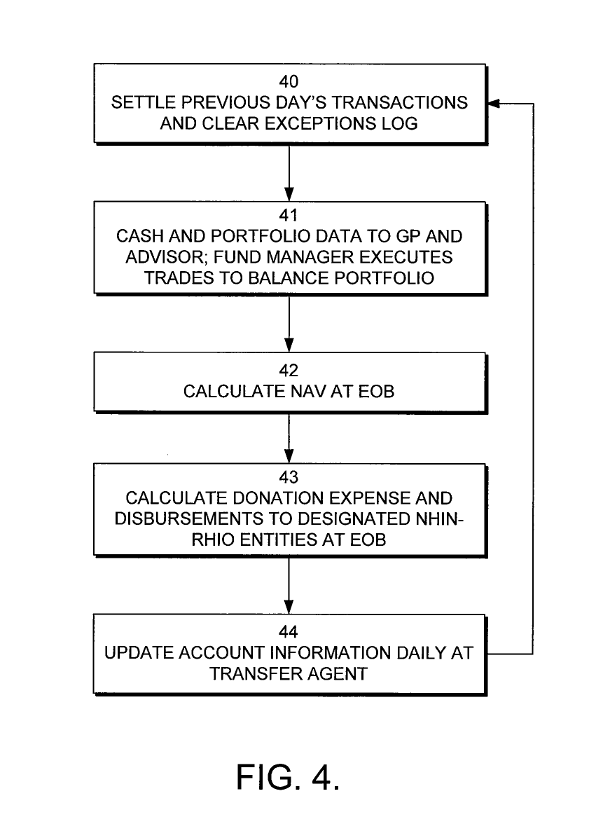

A method for daily funds operation in accordance with an embodiment of the present invention is depicted in the representative flow chart in FIG. 4. At some point after the completion of a business day, but prior to the commencement of the subsequent business day, the transactions from the last business day are settled at block 40. Thereafter the cash and portfolio information is delivered, at block 41, to the investment advisor who is responsible for the daily management of the fund portfolio. The NAV, as described above, is calculated by subtracting the fund's liabilities from its assets and dividing that by the number of outstanding shares at block 42. The donation expense is calculated as part of the daily fund valuation process at block 43. The daily donation expense can then be recorded as a single joint amount for the entire fund or the fund can apportion the daily donation amount and update the daily account information for its shareholders along with providing the shareholders with a transaction record and fund values at block 44. Then, the method cycles to block 40.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and within the scope of the claims.

What is claimed is:

1. A method of operating financial investment funds to finance one or more health information network entities, the method comprising:
creating one or more share classes of securities for investment management purposes;
designating a contribution amount for distribution to one or more health information network entity for said one or more share classes;
designating one or more health information network entities to receive said designated contribution amounts;
determining and revising the percentage allocations of the contribution amounts among the designated entities so as to meet the operating and investment objectives of the fund;
accumulating said contribution amounts for a designated period of time; and
distributing said accumulated contribution amounts to said designated health information network entity.

2. The method of claim 1, wherein said one or more health information network entities includes a National Health Information Network (NHIN) organization.

3. The method of claim 1, wherein said one or more health information network entities includes a Regional Health Information Organization (RHIO).

4. The method of claim 1, wherein the step of designating one or more health information network entities to receive said designated contribution amounts is performed by a general manager of said one or more share classes.

5. The method of claim 1, wherein said securities include bonds or other public debt instruments of the health information network entity; U.S. Treasury bills or notes; and other non-entity securities such as are compatible with the 501(c)(3) conformant organization of the health information network entity.

6. The method of claim 1, wherein said fund is a mutual fund.

7. The method of claim 5, wherein said one or more share classes are issued by a pre-existing open-end fund.

8. The method of claim 5, wherein said one or more share classes are issued by a pre-existing closed-end fund.

9. The method of claim 1, wherein said securities are publicly listed and traded.

10. The method of claim 1, wherein said fund has an investment objective of investing so as to capitalize and support ongoing operations of qualifying health information network entities.

11. The method of claim 1, wherein said fund is actively managed by an investment advisor.

12. The method of claim 1, wherein said designated period of time is one month and the step of distributing is performed on a monthly basis.

13. The method of claim 1, wherein said contribution amounts are withheld as a line item expense of said fund.

14. The method of claim 1, wherein the account data for said share classes of the fund includes an account for each of a plurality of shareholders.

15. The method of claim 14, wherein said account information includes reports generated for said shareholders and said designated health information network entities detailing the contribution amounts, dates of contributions and other information pertaining to said contribution amounts.

16. The method according to claim 14, wherein the step of distributing includes distributing said contribution amounts to said designated entities only after said contribution amounts for all of said shareholders designating said designated entity are above a predetermined minimum amount.

17. The method of claim 1, wherein said contribution amounts are designated as percentage values of the investment of said holder or the expenses of the fund.

18. The method of claim 17, wherein the account data of said fund includes a separate account for each of said health information network entities in which said individual fund designations of said shareholders are cumulated and said contribution amounts from said shareholders are calculated cumulatively.

19. The method of claim 1, wherein said fund is a common or collective fund.

20. A method of claim 1, further comprising the step of starting the fund, wherein starting said fund comprising:
issuing one or more share classes to be bought from and redeemed with said fund at a net asset value;
selling and redeeming said share classes to said holders;
obtaining designations of the health information network entities from said holders; and
maintaining account data for the outstanding share classes in one or more computers.

21. The method of claim 20, wherein said obtaining step further comprises requiring selection of said health information network entities from a list of health information network entities designated by said fund.

22. The method of claim 20, wherein said issuing step further comprises issuing one or more share classes that are listed for trading on a securities exchange and that are bought and sold at negotiated market prices.

23. The method of claim 22, further comprising having a secondary market holder purchase or sell one or more of said one or more share classes on the secondary market through a broker; and updating said account data for said secondary market holder on said one or more computers.

24. The method of claim 21, wherein the step of obtaining further comprises requiring selection of said health information network entities from a list of health information network entities designated by said fund.

25. A computerized method for record keeping for a fund with purposes having one or more share classes, the fund having a contribution amount designated for distribution to one or more health information network entities or causes, wherein holders of said one or more share classes designate health information network entities to receive said designated contribution amounts; and wherein said contribution amounts accumulated for a designated period of time and said accumulated contribution amounts are distributed to said designated health information network entities, the method comprising:
storing in a computer system information relating to said fund;
accepting investor capital from at least one holder;
storing information in the computer system relating to said at least one holder, wherein the stored information includes investor identification information, investment amounts, the terms of investments and the designations of said holder; and
storing information relating to said fund, wherein said stored information includes the investments and investment history of said fund and the contribution accumulation and distribution records and history for said designated NHIN or RHIO entities.
